(19) United States
(12) Patent Application Publication
(10) Pub. No.: US 2016/0143112 A1
(43) Pub. Date: May 19, 2016

(54) ELECTRONIC CONTROL OF OLEDS WITH DISTRIBUTED ELECTRODES

(71) Applicant: OLEDWorks GmbH, Aachen (DE)

(72) Inventors: Joseph Hendrik Anna Maria JACOBS, Eygelshoven (NL); Sören HARTMANN, Baesweiler (DE)

(21) Appl. No.: 15/001,462

(22) Filed: Jan. 20, 2016

Related U.S. Application Data
(63) Continuation of application No. PCT/EP2014/065758, filed on Jul. 22, 2014.

(30) Foreign Application Priority Data
Jul. 24, 2013 (EP) 13177830.0

(51) Int. Cl. H05B 33/08; H05B 37/02

(52) U.S. Cl. CPC H05B 33/0896; H05B 37/0227; H05B 37/0218

(57) ABSTRACT

The invention describes an Organic Light Emitting Device (1) comprising
an active layer (13) between a first electrode (11) and a second electrode (12);
electrical connectors (3, 34);
a plurality of current distributors (21) for electrically contacting at least the first electrode (11),
a plurality of selectively addressable current distribution lines (24, 25) being arranged to extend between the electrical connectors (3, 34) and the current distributors (21);
a power supply (100) being electrically connected to the electrical connectors (3, 34), the powers supply (100) comprising a controller (110), the controller (110) being adapted to control a current flow to the current distributors (21) based on electrical parameters characterizing the brightness of an area (22) of the Organic Light Emitting Device (1) around the current distributors (21), and
at least one sensor (200), the sensor (200) being adapted to measure data being relevant for the brightness distribution of the Organic Light Emitting Device (1), and the controller (110) being adapted to adapt the electrical parameters based on the data measured by the sensor (200). The invention further describes a corresponding method of controlling the brightness distribution of an Organic Light Emitting Device (1) and a method of driving the Organic Light Emitting Device (1). The sensor enables a feedback loop for locally controlling the brightness of the Organic Light Emitting Device (1) by means of the current distributors (21).

### FIELD OF THE INVENTION

The invention describes an Organic Light Emitting Device (OLED) with distributed electrodes, a sensor and a power supply, a method of controlling the brightness distribution of such an OLED and a corresponding method of driving an OLED.

### BACKGROUND OF THE INVENTION

An organic light-emitting diode (OLED) device is manufactured by building up a series of layers, usually comprising an active or organic layer sandwiched between an anode and a cathode. A voltage is applied across the anode and cathode using contact pads arranged along one or more sides of the device, while the remainder of the device is encapsulated to protect the active layer from moisture, oxygen and other contaminations. An OLED device can be top-emitting and/or bottom-emitting, depending on whether one or both of the electrodes are transparent. For example, for a bottom-emitting device, a transparent anode can be applied onto a transparent carrier such as glass using a layer of a Transparent Conducting Oxide (TCO), for example indium tin oxide (ITO). The organic layer and the cathode are then applied onto the anode before the device is finally encapsulated. However, a transparent electrode is generally also associated with a poor lateral conductivity. As a result, the brightness over the light emitting area in such an OLED can noticeably drop off towards the center. For OLEDs used in illumination applications requiring a homogenous brightness over the light emitting area, this problem is usually circumvented by an additional structure of thin metal shunt lines applied onto the transparent electrode in order to enhance its conductivity. However, these shunt lines are inflexible and not suitable for large area OLEDs.

### SUMMARY OF THE INVENTION

It is thus an object of the present invention to provide an OLED with improved brightness distribution, an improved method of controlling the brightness distribution of an OLED and an improved method of driving an OLED.

According to a first aspect an OLED is provided, the OLED comprises an active layer between a first electrode and a second electrode. The OLED further comprises electrical connectors for connecting the OLED panel to a power supply. The OLED further comprises a plurality of current distributors for electrically contacting the first and/or the second electrode to the power supply. The current distributors may comprise contact pads which may be provided in a regular pattern on the first and/or second electrode. It may be preferred to provide the contact pads only on one electrode in case the OLED emits only light in one direction. The size of the contact pads should be small such that they are invisible or nearly invisible for a viewer of a light emitting OLED. The current distributors may comprise a plurality of openings or vias, wherein an opening extends through the second electrode and the active layer to expose an area of the first electrode; and a plurality of selectively addressable current distribution lines, wherein a current distribution line is arranged to extend between an electrical connector and a contact pad on the first electrode such that an electrical connection can be established between the power supply and the first electrode to specifically regulate the brightness of the active layer in the vicinity of the contact pad by that current distribution line. The current distribution lines are electrically connected to each other by means of the first electrode. The power supply is electrically connected to the electrical connectors. The power supply comprises a controller which is adapted to control a current flow to the current distributors and thus the contact pads on the first electrode based on electrical parameters characterizing the brightness of an area of the OLED around the contact pads of the current distributors.

The electrical parameters may be determined by means of calibration of the OLED after manufacturing of the OLED. In a first calibration step the same current and voltage may be provided to the current distributors. In a second calibration step the current and/or voltage supplied to the different current distributors may be varied until a homogeneous or at least more homogeneous brightness distribution in comparison to supplying equal voltage and current to the current distributors is achieved. The electrical parameters for each current distributor determined by means of the calibration may be stored in a memory device of the controller such that the OLED can be driven by means of the power supply using the electrical parameters in order to improve the brightness distribution of the OLED. The brightness distribution may comprise a color point distribution. The measurements by means of the sensors may thus be used to adapt the electrical parameters in order to compensate inhomogeneities of the color point distribution.

The OLED further comprises at least one sensor. The sensor is adapted to measure data like temperature, electrical characteristics of the OLED, ambient light and the like which may be relevant for the brightness and/or brightness distribution of the OLED. The controller may use the measured data to adapt the electrical parameters such that a more homogeneous lighting distribution is achieved. The brightness may be influenced by the ambient temperature or aging of the OLED. The electrical parameters as current and/or voltage applied to the current distributors are corrected based on the data measured by the sensor. The correction may be based on a known functional dependency of the respective electrical parameter on the physical parameter measured by the sensor as, for example, a known temperature dependency. The functional dependency may be stored in the memory device of the controller. Alternatively or in addition the dependency may be determined during the calibration by measuring the electrical parameters depending on the ambient temperature and the like and store the results in a look up table in the memory device of the controller.

Especially large OLEDs may be confronted with the problem that different areas of the OLED may have different temperatures. Reasons may be external heat sources, varying heat transferring properties as air flow or different surface properties. Furthermore, the OLED itself may produce heat which is not evenly distributed across the OLED. Two, three, four or more sensors may thus be used to measure the temperature of different areas of the OLED. The electrical parameters can be adapted to the temperature data measured by the sensors such that visible brightness variations caused by the temperature variations can be minimized by means of the controller.

Beside temperature sensors it may be advantageous to provide two, three, four or a multitude of sensors measuring the ambient light at different areas of the OLED. The ambient light may cause unwanted brightness variations and the measurement data of the ambient light sensors may be used to correct the electrical parameters in order to improve or adapt the brightness distribution of OLED to the ambient light. The measurement data of the ambient light sensors may also be used to determine ambient light induced aging of the OLED and compensate the aging by means of adapting or correcting the electrical parameters based on the measurement data of the respective area of the OLED. Such adaption may, for example, be necessary if only a part of an OLED is exposed to direct sun light. The measurement of ambient light may be combined with temperature measurement.

The local electrical characteristics as impedances and the like of the current distributors may be an indicator of the brightness of the OLED in an area around the contact pad. It may thus be advantageous to measure such electrical characteristics of at least a part (e.g. checker board pattern) or all of the current distributors. Regular measurements of the electrical characteristics may be used to provide a feedback loop for correcting or adapting the electrical parameters. The electrical parameters may be adapted in accordance with a known functional dependency of the brightness on the electrical characteristics stored in the memory device of the controller. Alternatively or in addition the dependency may be determined by measuring the dependency of the electrical parameters on the electrical characteristics of a number of OLEDs. The results may be analyzed and average values may be calculated. The average values may be stored in a look up table in the memory device of the controller. The measurements may be combined with aging measurements such that aging induced brightness variations may be locally compensated by adapting or correcting the electrical parameters of the respective current distributors.

A part or all of the current distributors may comprise a temperature sensor such that the temperature of the OLED can be measured locally. The contact between the current distributor and the TCO of the first electrode may, for example, be used as thermocouple. The current distribution line may consist of silver, aluminum or the like. The first electrode may consist of a TCO like, for example, Indium Tin Oxide (ITO). The contact between, for example, silver and ITO may be used as thermocouple. The local temperatures may be used to adapt or control the electrical parameters based on the measurement data provided by the thermocouples. Local variations of the temperature within the layer structure of the OLED may be detected by means of such integrated thermocouples in order to provide a homogeneous brightness profile. The thermocouples may also be used to determine potential malfunctions of the OLED by detecting local heating of the OLED.

The controller of the power supply may control the power supply to drive the OLED in a lighting mode and a sensor mode. The OLED emits light in the lighting mode and sensor data is acquired in the sensor mode. The lighting mode may be characterized by high currents. In the sensor mode only limited power is supplied to the OLED in order to minimize disturbance of the measurement. The lighting and sensor mode may be arranged in a way that the sensor mode cannot be observed during light emission by the OLED. The sensor mode may thus comprise only short periods in between relatively long lighting periods of the lighting mode. The sensor mode may comprise an electrical characteristics determining mode for determining the electrical characteristics of at least a part of the current distributors. The sensor mode may alternatively or in addition comprise a measurement data mode for determining the measurement data of the thermocouple. The power supply may, for example, provide defined DC or AC voltage to the OLED panel in order to measure the impedance of the current distributors whereby in the measurement data mode no voltage or a defined DC offset voltage is provided in order to minimize the influence of the power supply. The sensor mode may be applied to all current distributors or only a sub group of current distributors in order to minimize the effect regarding light emission. The impedance of the current distributors may even be measured one after the other using a scanning scheme.

The OLED may further comprise an optical sensor like a CCD chip or optical MOS in order to measure the brightness distribution and/or color point distribution of the OLED. One or more optical sensors may be integrated, for example, in the edge or corner of the OLED. The controller may use the measured brightness and/or color point distribution to adapt the electrical parameters such that the homogeneity of the brightness and/or color point distribution is improved. The data provided by the optical sensor may be used in combination with data provided by temperature sensors, ambient light sensors or sensors measuring the electrical characteristics of the current distributors. A combination of all this measurement data may enable a full feedback control of the OLED.

Instead of integrating the optical sensor it may be possible integrate a receiver for receiving measurement data of an optical sensor for determining the brightness distribution and/or color point distribution of the OLED. A camera, mobile phone or a specific optical device comprising such an optical sensor may be used to measure the brightness and/or color point distribution of the OLED. The measurement data may be transferred to the OLED via the receiver such that the controller may adapt the electrical parameters based on the measured brightness distribution. The data provided by the measurement device comprising the optical sensor(s) has to be in a format which can be processed by the controller. The receiver may be a wireless or wired interface which can be connected to the measurement device. The receiver thus enables a calibration of the OLED. The OLED may even be enabled by means of a transceiver to request a calibration in case of irregular measurement data provided by one or more of the sensors described above. Measurement data provided by temperature, ambient light or electrical sensors may be used to support the calibration. Ambient light sensors may, for example, be used to enable a compensation of ambient light in the brightness distribution and/or color point distribution provided by the measurement device.

In accordance with a further aspect of the present invention a method of controlling the brightness distribution of an OLED described above is provided. The method comprises the steps of;
providing electrical parameters characterizing the brightness of an area of the Organic Light Emitting Device around the current distributors;
measuring data being relevant for the brightness and/or brightness distribution of the Organic Light Emitting Device;
adapting the electrical parameters based on the measured data; and
controlling the Organic Light Emitting Device based on the adapted electrical parameters.

Data being relevant for the brightness and/or brightness distribution of the OLED may be, for example, the impedance of the individual OLED parts connected to each current distributor or the brightness distribution of the OLED. Variations of the brightness may be correlated with the electrical characteristics or the local temperature of the OLED. The electrical parameters may thus be adapted by means of the correlation between the measured brightness distribution and the measured impedance of the individual OLED parts connected to each current distributor or local temperature of the OLED.

In accordance with a further aspect of the present invention a method of driving an OLED described above is provided. The method comprises the steps of:
providing a lighting mode for emitting light;
providing at sensor mode for measuring data being relevant for the brightness and/or brightness distribution of the Organic Light Emitting Device.

The sensor mode may be used between two lighting periods in order to determine the impedance of the current distributors and/or to measure the local temperature of the OLED panel by means of temperature sensors. Power supply to the OLED panel may be low in the sensor mode in order to minimize the influence with respect to the measurement data acquired by means of the sensor or sensors.

It shall be understood that the OLED of claim 1 and the methods of claim 11 or 15 have similar and/or identical embodiments, in particular, as defined in the dependent claims.

It shall be understood that a preferred embodiment of the invention can also be any combination of the dependent claims with the respective independent claim.

Further advantageous embodiments are defined below.

### BRIEF DESCRIPTION OF THE DRAWINGS

These and other aspects of the invention will be apparent from and elucidated with reference to the embodiments described hereinafter.

The invention will now be described, by way of example, based on embodiments with reference to the accompanying drawings.

In the drawings:

FIG. 1 shows a cross-section through an OLED panel;

FIG. 2 shows a plan view of an OLED panel;

FIG. 3 shows a first embodiment of an OLED;

FIG. 4 shows a second embodiment of an OLED;

FIG. 5 shows a lighting mode and a sensor mode provided by the power supply;

FIG. 6 shows a principal sketch of a method of controlling the brightness distribution of an OLED.

In the Figures, like numbers refer to like objects throughout. Objects in the Figures are not necessarily drawn to scale.

### DETAILED DESCRIPTION OF EMBODIMENTS

Various embodiments of the invention will now be described by means of the Figures.

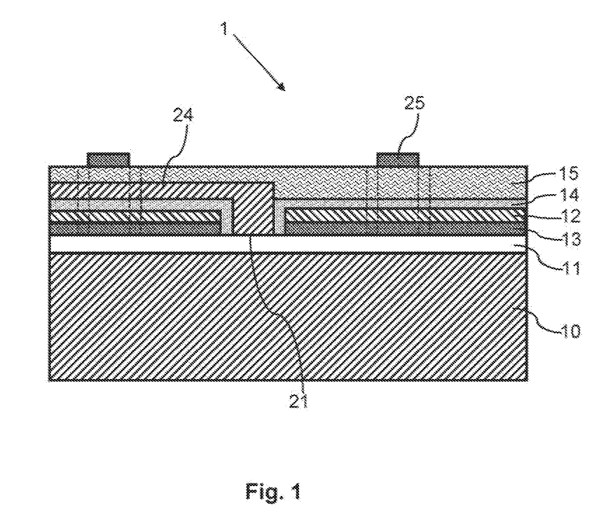

FIG. 1 shows a cross-section through an OLED panel which may be comprised by an OLED 1 according to the present invention. The cross-section shows a stack of layers 10, 11, 12, 13, 14 and 15 and current distribution lines 24 and 25. The layer thicknesses of the electrodes 11, 12 and the active layer 13, the insulating layers 14, 15 and the current distribution lines 24, 25 are exaggerated in relation to the thickness of the carrier 10. The carrier 10 may be, for example, a transparent glass or plastic substrate. The first electrode 11 is a TCO layer attached to the carrier 10. The OLED panel is thus arranged to emit light through the carrier (bottom emitter) if driven by a power supply 100. The active or electroluminescent layer 13 is attached on top of the first electrode 11, and the second electrode 12 is on top of the active layer 13. These layers 11, 12, 13 can all be applied successively using a suitable technique such as spin coating to ensure favorably thin and even layers without any cast-intensive structuring. Openings 20 are formed in the stack of layers 12 and 13, for example, by means of laser ablation of the second electrode 12 and the active layer 13. In this way, an area of the first electrode 11 is exposed. The first insulating layer 14 coats the second electrode 12 in order to electrically insulate the current distribution line 24 contacting the exposed area with respect to the second electrode 12. The insulating material 14 may be printed as a thin layer on top of the second electrode 12 and laser ablation in the region of the area such that the insulating material 14 ensures that the second electrode 12 remains electrically isolated from the first electrode 11 and the current distribution line. The current distribution line 24 is printed onto the first insulating layer 14 such that the material of the current distribution line 24 is electrically connected with the exposed area of the first electrode 11 building a current distributor 21. In the embodiment shown, the first electrode 11 can be applied using a TCO such as indium tin oxide, which is known to have a poor lateral conductivity. Depending on the size of the OLED panel more than one layer of current distribution lines 24, 25 may be needed. In the embodiment shown in FIG. 1 a second insulating layer 15 is used to isolate a second layer of current distribution lines 25 with respect to the first layer of current distribution lines 24 in order to enable crossings. The current distribution lines 25 as well as the current distribution lines 24 are electrically connected to the first electrode 11 via further openings 20 indicated by the dashed lines also passing the first insulating layer 14. The processing of the further openings 20, the additional insulating layer 15 and the second layer of current distribution lines 25 may be the same as the processing of the openings 20 through the second electrode 13 and the active layer 12, the processing of the first insulating layer 14 and the processing of the first layer of current distribution lines 24. The second electrode 12 can be any suitable conducting material such as aluminum, copper, gold, etc. The active layer 13 can comprise one or more layers of any suitable organic or inorganic electroluminescent material, as well as any number of additional hole/electron emitting and transport layers, as appropriate. The insulating layers 14, 15 can comprise any dielectric or electrically insulating material that does not negatively affect the properties of the OLED, e.g. SiN, SiO, SiON, Al₂O₃, TiO₂, photoresist, etc. The first electrode 11 may even be segmented, e.g. squares, hexagons and the like, with one current distribution line 14, 15 contacting each of these segments. FIG. 1 shows a bottom emitter. The current distributors can also be used in case of a top emitting OLED the current distribution lines 24, 25 may in this case provided between the carrier 10 and the first electrode 11. The current distributors are in this case used to contact the second (top) electrode 12. It may also be possible to use the current distributors in combination with two transparent electrodes. In this case no openings in one of the electrodes and the active layer may be needed. This approach may be limited to relatively small OLED panels in view of the threshold between visibility of the current distribution lines and electrical conductivity of the current distribution lines.

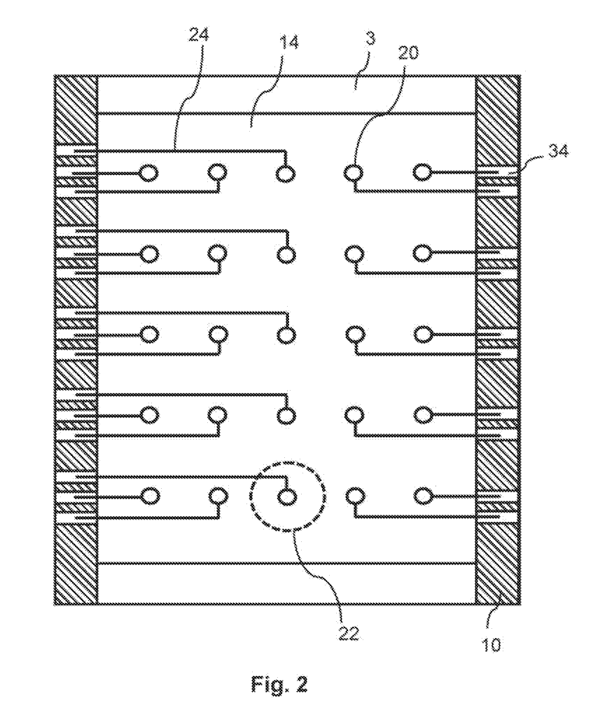

A very simplified plan view of an OLED panel being part of an OLED 1 is shown in FIG. 2. A plurality of current distribution lines 24 is shown, whereby each current distribution line 24 electrically connects the first electrode (through an opening 20) to a contact area forming electrical connectors 34 for electrically connecting the first electrode 11 on the carrier or substrate 10 along the side of the OLED panel to a power supply (not shown). The current distribution lines 24 may also be extended in the plane of the layer. The essential feature of the current distribution lines 24 is that the addressability of single contacts of the current distributors 21 to the first electrode 11 or at least a subgroup of contacts of the current distributors 21 to the first electrode 11 (preferably adjacent to each other) is enabled. The OLED panel further comprises electrical connectors 3 for electrically connecting the second electrode 12 to the power supply. Here, only a few openings 20 and current distribution lines 24 are shown. There is no need for a further layer of current distribution lines 25. An OLED panel with a light-emitting area of 25 cm² may have an array of tens or hundreds of openings (or even more) and a corresponding number of current distribution lines 24. During operation, a voltage is applied between the electrodes of the OLED panel by means of the power supply. An area or cell 22 in the vicinity of an opening 20 can only emit light as long as a potential difference is maintained by means of the power supply between the first electrode 11 and the second electrode 13. FIG. 2 shows one such cell 22, and it will be understood that each opening 20 is effectively in the middle of such a cell 22. The brightness of the OLED panel may vary locally, for example, due to manufacturing tolerances. The current distribution lines 24 are used to locally adapt the current flow through the active layer 13 and thus influence the brightness of the OLED panel in the vicinity of the contact or contact pad between the current distribution line 24 and the first electrode 11 (cell 22). The latter is possible because of the poor conductivity of the TCO. The current distribution lines 24 can thus be used to provide a uniformly bright or homogenous light-emitting area over the entire surface. The current distribution lines may be integrated in the layer stack of the OLED panel as depicted in FIGS. 1 and 2 or they may be provided by means of a cover lid encapsulating the OLED panel. Alternatively, it may also be possible to glue a PCB on top of the OLED in such a way that bottom contacts of the PCB contact to the current distributors 21 of the OLED.

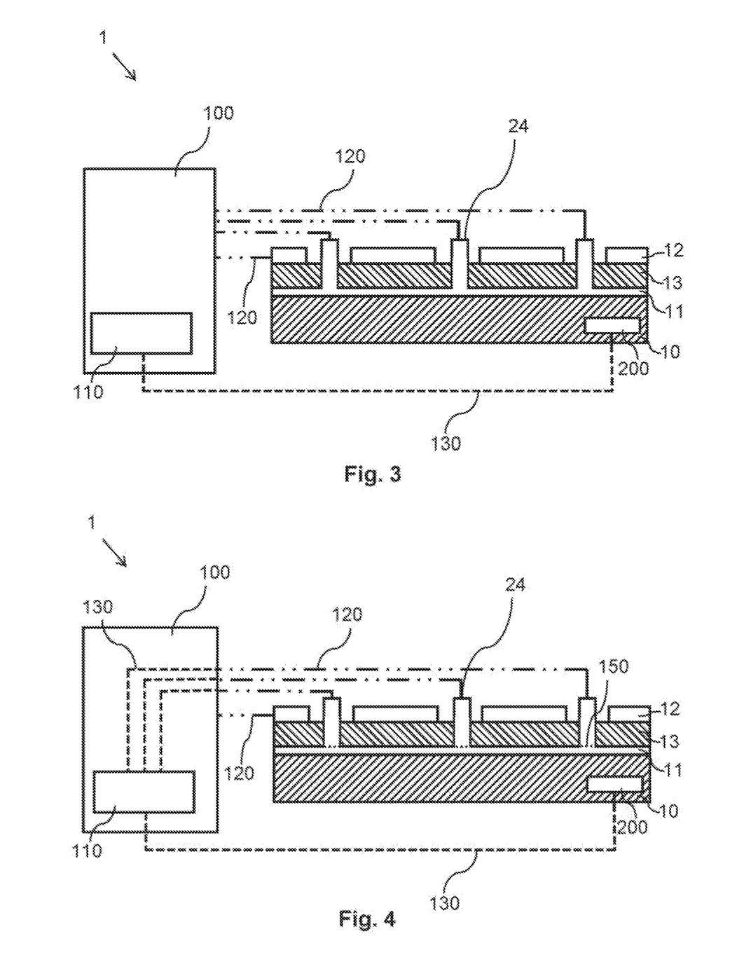

FIG. 3 shows an OLED 1 comprising an OLED panel with a carrier 10, first electrode 11, active layer 13 and second electrode 12. The current distribution lines 24 are each electrically connected by driving lines 120 to a power supply 100. The power supply 100 comprises a controller 110. The controller 110 controls a current flow to the current distribution lines 24 and thus contact pads on the first electrode 11 based on electrical parameters characterizing the brightness of an area of the OLED 1 around the contact pads (cell 22). The electrical parameters are determined within a calibration procedure after production of the OLED panel and are stored in a memory device of the controller 110. The electrical parameters may depend on the ambient temperature of the OLED panel. Therefore, a temperature sensor 200 is attached to the OLED panel (in this special case integrated in the substrate 10). The temperature sensor 200 measures the ambient temperature in the vicinity of the OLED panel and provides the measurement data via data line 130 to the controller 110. The controller 110 adapts the electrical parameters in dependence on the ambient temperature by means of a look up table determined during the calibration procedure and stored in the memory device. The power supply finally supplies power via driving lines 120 to each current distributor 21 and thus the first electrode 11 and power line 120 electrically connected to the second electrode 12. In addition a further power line 120 may be used to contact the first electrode 11 in order to provide the main part of the power and power lines 120 connected to the current distributors 21 may only be used to compensate variations of the brightness and/or color distribution of the OLED.

In FIG. 4 a further OLED 1 is shown. In addition to the OLED 1 shown in FIG. 4 each current distribution line 24 is connected to a data line 130 via the driving lines 120. It would alternatively be possible to provide separate data lines 130 to the current distribution lines 24. The controller 110 measures the voltage and/or impedance (capacitance, resistance, inductance) of the current distribution lines 24, the contact of the current distribution lines 24 to the first electrode 11, the first electrode 11 and the second electrode 12 taking into account the known impedance of data lines 130 and driving lines 120. The driving current applied to each current distributor 21 via driving lines 120 is adapted by means of the controller 110 based on the measured impedance and a look up table stored in the memory device of the controller 110. The look up table is determined by characterizing the brightness of a multitude of OLED panels. Alternatively, the brightness distribution of the OLED panel electrically connected to the power supply 100 may be measured by means of an optical sensor in dependence on the electrical parameters and the measured impedances. The impedances may for example be influenced by the local temperature of the OLED panel. Each current distribution line 24 may alternatively or in addition comprise one temperature sensor like a thermocouple measuring the local temperature of the OLED panel near to the contact pad of the current distribution line 24 on the first electrode. The temperature sensor may for example be the contact between the material of the current distribution lines 24 and the first electrode 11 building a thermocouple 150. The controller 110 locally adapts the electrical parameters like voltage and current supplied to the first electrode by means of current distributors 21 based on the measured temperatures such that a homogeneous brightness distribution is achieved.

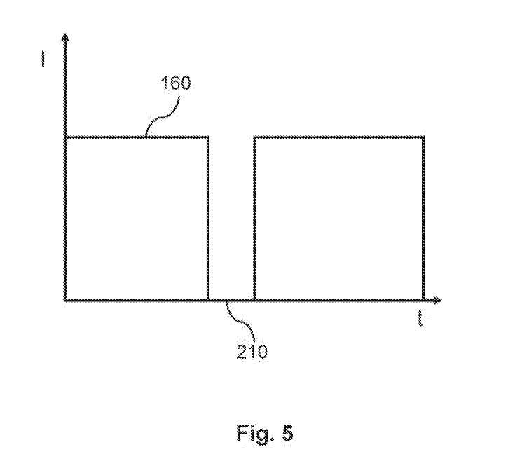

FIG. 5 shows a driving scheme for driving the OLED by means of the power supply 100. The controller 110 provides a lighting mode 160 with a constant current supplied to the OLED panel. In a sensor mode 210 essentially no current is supplied to the OLED panel. The measurement of small voltages measured by, for example, thermocouples may thus be simplified. The timing and duration of the sensor mode is arranged in such a way that there is no visible flicker for a viewer of the OLED.

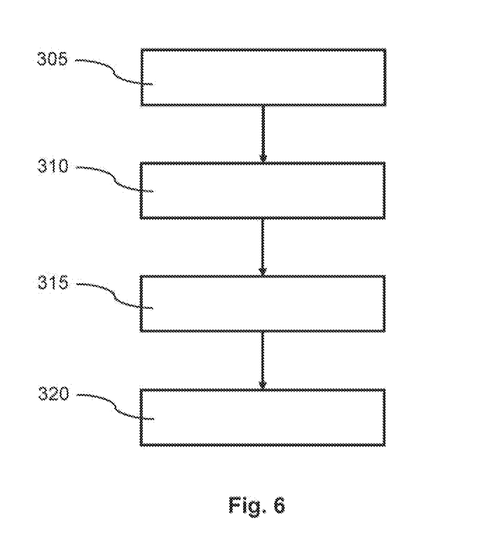

FIG. 6 shows a principal sketch of a method of controlling the brightness distribution of an OLED 1 as shown in FIGS. 3 and 4. In step 305 electrical parameters characterizing the brightness of an area of the OLED 1 around the current distributors are provided. In step 310 data are measured being relevant for the brightness and/or brightness distribution of the OLED 1. In step 315 the electrical parameters are adapted based on the measured data, and the OLED 1 is in step 320 controlled based on the adapted electrical parameters.

The invention enables to control the brightness distribution which may be caused by the poor electrical conductivity of the transparent electrode. The transparent electrode may be the top electrode not in contact with the substrate (top emitter) or the bottom electrode being in contact with the substrate (bottom emitter). The invention may also be used in combination with transparent OLEDs in combination with both electrodes.

While the invention has been illustrated and described in detail in the drawings and the foregoing description, such illustration and description are to be considered illustrative or exemplary and not restrictive.

From reading the present disclosure, other modifications will be apparent to persons skilled in the art. Such modifications may involve other features which are already known in the art and which may be used instead of or in addition to features already described herein.

Variations to the disclosed embodiments can be understood and effected by those skilled in the art, from a study of the drawings, the disclosure and the appended claims. In the claims, the word “comprising” does not exclude other elements or steps, and the indefinite article “a” or “an” does not exclude a plurality of elements or steps. The mere fact that certain measures are recited in mutually different dependent claims does not indicate that a combination of these measures cannot be used to advantage.

Any reference signs in the claims should not be construed as limiting the scope thereof.

### LIST OF REFERENCE NUMERALS

3 electrical connector for second electrode
10 carrier
11 first electrode
12 second electrode
13 active layer
14 first insulating layer
15 second insulating layer
20 opening
21 current distributor
24, 25 current distribution lines
34 electrical connector for first electrode
100 power supply
110 controller
120 driving line
130 data line
150 thermocouple
160 lighting mode
200 sensor
210 sensor mode
305 step of providing electrical parameters
310 step of measuring data
315 step of adapting electrical parameters
320 step of controlling OLED

1. An Organic Light Emitting Device comprising;
an active layer between a first electrode and a second electrode;
electrical connectors;
a plurality of current distributors for electrically contacting at least the first electrode or the second electrode;
the current distributors comprising a plurality of selectively addressable current distribution lines arranged to extend between the electrical connectors and contact pads on the first electrode;
the power supply being electrically connected to the electrical connectors, the power supply comprising a controller, the controller being adapted to control a current flow to the current distributors based on electrical parameters characterizing a brightness of an area of the Organic Light Emitting Device around the contact pads; and
at least one sensor, the sensor being adapted to measure data being relevant for a brightness distribution of the Organic Light Emitting Device, and the controller being adapted to adapt the electrical parameters based on the data measured by the sensor.

2. The Organic Light Emitting Device according to claim 1 comprising a multitude of sensors measuring a temperature of different areas of the Organic Light Emitting Device such that the electrical parameters can be adapted to temperature data measured by the sensors.

3. The Organic Light Emitting Device according to claim 1 comprising a multitude of sensors measuring ambient light at different areas of the Organic Light Emitting Device such that the electrical parameters can be adapted to ambient light data measured by the sensors.

4. The Organic Light Emitting Device according to claim 1, wherein electrical characteristics of at least a part of the plurality of current distributors are measured and the controller being adapted to adapt the electrical parameters based on the measured electrical characteristics.

5. The Organic Light Emitting Device according to claim 1, wherein at least a part of the plurality of current distributors comprise a temperature sensor, and the controller being adapted to adapt the electrical parameters based on measurement data provided by the temperature sensor.

6. The Organic Light Emitting Device according to claim 5, wherein the temperature sensor is an electrical contact between the current distributors and the first electrode forming a thermocouple.

7. The Organic Light Emitting Device according to claim 1, wherein the controller is adapted to control the power supply to provide a lighting mode for emitting light and a sensor mode for measuring data being relevant for the brightness and/or brightness distribution of the Organic Light Emitting Device.

8. The Organic Light Emitting Device according to claim 7, wherein the sensor mode comprises an electrical characteristics determining mode for determining electrical characteristics of at least a part of the current distributors and/or a measurement data mode for determining measurement data of the temperature sensor.

9. The Organic Light Emitting Device according to claim 1, comprising an optical sensor for determining a brightness distribution of the Organic Light Emitting Device, and the controller being adapted to adapt the electrical parameters based on the measured brightness distribution.

10. The Organic Light Emitting Device according to claim 1, comprising a receiver for receiving measurement data of an optical sensor for determining a brightness distribution of the Organic Light Emitting Device, and the controller being adapted to adapt the electrical parameters based on the measured brightness distribution.

11. A method of controlling a brightness distribution of an Organic Light Emitting Device comprising an active layer between a first electrode and a second electrode; electrical connectors; and a plurality of current distributors for electrically contacting at least the first electrode or the second electrode, the current distributors comprising a plurality of selectively addressable current distribution lines arranged to extend between the electrical connectors and contact pads on the first electrode; a power supply being electrically connected to the electrical connectors, the power supply comprising a controller, the controller being adapted to control a current flow to the current distributors based on electrical parameters characterizing a brightness of an area of the Organic Light Emitting Device around the contact pads; and at least one sensor, the sensor being adapted to measure data being relevant for a brightness distribution of the Organic Light Emitting Device, and the controller being adapted to adapt the electrical parameters based on the data measured by the sensor, wherein, the method comprises the steps of:
providing electrical parameters characterizing a brightness of an area of the Organic Light Emitting Device around current distributors;
measuring data being relevant for a brightness and/or brightness distribution of the Organic Light Emitting Device;
adapting the electrical parameters based on the measured data; and
controlling the Organic Light Emitting Device based on the adapted electrical parameters.

12. The method according to claim 11, wherein the step of measuring data being relevant for the brightness distribution of the Organic Light Emitting Device comprises the step of:
measuring a voltage and/or an impedance of the current distributors.

13. The method according to claim 11, wherein the step of measuring data being relevant for the brightness and/or brightness distribution of the Organic Light Emitting Device comprises the step of:
measuring the brightness distribution of the Organic Light Emitting Device.

14. The method according to claim 13, wherein the step of adapting the electrical parameters based on the measured data comprises the step of:
adapting the electrical parameters based on the correlation between the measured brightness distribution and the measured impedance.

15. A method of driving an Organic Light Emitting Device comprising an active layer between a first electrode and a second electrode; electrical connectors; and a plurality of current distributors for electrically contacting at least the first electrode or the second electrode, the current distributors comprising a plurality of selectively addressable current distribution lines arranged to extend between the electrical connectors and contact pads on the first electrode; a power supply being electrically connected to the electrical connectors, the power supply comprising a controller, the controller being adapted to control a current flow to the current distributors based on electrical parameters characterizing a brightness of an area of the Organic Light Emitting Device around the contact pads; and at least one sensor, the sensor being adapted to measure data being relevant for a brightness distribution of the Organic Light Emitting Device, and the controller being adapted to adapt the electrical parameters based on the data measured by the sensor, wherein, the method comprises the steps of:
providing a lighting mode for emitting light;
providing at sensor mode for measuring data being relevant for a brightness distribution of the Organic Light Emitting Device.
